(19) United States
(12) Patent Application Publication
(10) Pub. No.: US 2019/0220869 A1
(43) Pub. Date: Jul. 18, 2019

(54) Compliance of Joint Marketing Services for Parties involved in the Real Estate Settlement Process as in the RESPA Act of 1974 and Amendments

(71) Applicant: AROOJ ABDULLAH SHEIKH, PEARLAND, TX (US)

(72) Inventor: AROOJ ABDULLAH SHEIKH, PEARLAND, TX (US)

(21) Appl. No.: 15/874,857

(22) Filed: Jan. 18, 2018

(51) Int. Cl. G06Q 30/02; G06Q 20/02; G06Q 50/16

(52) U.S. Cl. CPC G06Q 30/02; G06Q 50/16; G06Q 20/02

(57) ABSTRACT

Compliance of joint marketing services led by a non-government third party for parties involved in the real estate settlement process as in the RESPA Act of 1974 and Amendments.

### CROSS REFERENCE TO RELATED APPLICATIONS

Nonapplicable.

### FEDERALLY SPONSORED RESEARCH

Nonapplicable.

### DESCRIPTION

### BACKGROUND

Regulation X, the Real Estate Settlement Procedures Act of 1974 (RESPA) (12 U.S.C. 2601 et seq.), including any amendments that are effective as of filing this patent application. RESPA binds parties involved in the real estate settlement process to a code of ethics, limiting their interactions, and thus their marketing efforts by ensuring there is no exchange of a “thing of value”.

### BACKGROUND—PRIOR ART

Nonapplicable.

### SUMMARY OF THE INVENTION

The invention serves to ease the problem identified in the background for parties involved in the real estate settlement process as in the RESPA Act of 1974 and Amendments, by allowing for a non-government third party to confirm the compliance and ethicality of joint marketing that occurs among parties involved in the real estate settlement process as in the RESPA Act of 1974 and Amendments.

The invention is a process where a non-government third party offers marketing services subscribed to jointly by parties involved in real estate settlement process as in the RESPA Act of 1974 and Amendments and charged to each party in compliance to RESPA to confirm the parties do not exchange a thing of value and such services are not conditioned on the referral of business. The non-government third party may also manage the compliance and may charge a compliance fee separate from the marketing service fee to confirm compliance. This may include record keeping of such compliance relevant to each joint marketing activity.

### DETAILED DESCRIPTION OF EXEMPLARY EMBODIMENTS

### Detailed Description—First Embodiment

This invention allows a non-government third party to provide compliance as a service to parties involved in the real estate settlement process as in the RESPA Act of 1974 and Amendments for joint marketing services. The non-government third party ensures a RESPA compliant transaction by charging both parties for a marketing service, activity, or product to ensure no “thing of value” is exchanged. The non-government third party may offer RESPA compliance as an additional service in conjunction with a joint marketing product, service or activity. The non-government third party may offer RESPA compliance included with a joint marketing service, product, or activity. The non-government third party may allow parties with a pre-existing relationship to participate in RESPA compliant joint marketing. The non-government third party may pair or group parties involved in the real estate settlement process as in the RESPA Act of 1974 and Amendments for the purpose of participating in RESPA compliant joint marketing.

### Operation—First Embodiment

A non-government third party will offer a joint marketing service, activity, or product for which all participating Parties involved in the real estate settlement process as in the RESPA Act of 1974 and Amendments are charged a fee in compliance to RESPA. The non-government third party confirms in good faith by monitoring the transaction that the transaction did not result in violation of RESPA Act of 1974 and Amendments and that the participating parties involved in the real estate settlement process as in the RESPA Act of 1974 and Amendments do not exchange a “thing of value”. The non-government third party may execute the transaction fully or to a certain extent.

A non-government third party sells parties involved in the real estate settlement process as in the RESPA Act of 1974 and Amendments a product that all parties jointly, equally or proportionately subscribe to through a consensus and charges all parties accordingly in such transaction a fee in compliance to RESPA.

A non-government third party sells parties involved in the real estate settlement process as in the RESPA Act of 1974 and Amendments a service that all parties jointly, equally or proportionately have access to and charges all parties accordingly in such transaction a fee in compliance to RESPA.

A non-government third party accordingly charges a fee to multiple parties involved in the real estate settlement process as in the RESPA Act of 1974 and Amendments for an activity that all parties jointly, equally or proportionately participate in, through a consensus, although there may be varying definitions of participation for each of the parties.

Although the description above contains many specificities, these should not be construed as limiting the scope of the embodiments but as merely providing some illustrations of some of several embodiments.

### Detailed Description—Additional Embodiment

The scope of the invention includes marketing activities that are deemed RESPA compliant by a non-government third party in good faith by monitoring the transaction in compliance pertaining to marketing to parties involved in the real estate settlement process as in the RESPA Act of 1974 and Amendments. This includes the ability to offer joint marketing products and joint marketing services that are in good faith by monitoring the transaxtion deemed legally compliant for parties involved in the real estate settlement process as in the RESPA Act of 1974 and Amendments. This also includes joint promotional exercises for parties involved in the real estate settlement process as in the RESPA Act of 1974 and Amendments.

### Operation—Additional Embodiment (Optional)

Examples of the joint marketing exercises for parties involved in the real estate settlement process as in the RESPA Act of 1974 and Amendments include, but are not limited to the following:

Joint party real estate sign: Join real estate signs for multiple parties involved in the real estate settlement process as in the RESPA Act of 1974 and Amendments is covered in the scope of marketing activities. These signs may have multiple sides or multiple spaces for information. These signs may also include add ons, including but not limited to spaces where additional information or materials may be placed.

Webinars: Joint webinars for multiple parties involved in the real estate settlement process as in the RESPA Act of 1974 and Amendments is covered in the scope of marketing activities.

Press/Media: Joint press and media for multiple parties involved in the real estate settlement process as in the RESPA Act of 1974 and Amendments is covered in the scope of marketing activities. Press and media include, but are not limited to videos and any type of publications including but not limited to newspapers and magazines.

Online Promotions: Online joint promotions for multiple parties involved in the real estate settlement process as in the RESPA Act of 1974 and Amendments is covered in the scope of marketing activities. Online promotions include, but are not limited to search engine optimization, search engine marketing, online advertising, and any online publications, on platforms including but not limited to journals, websites, and newspapers.

Events: Joint events for multiple parties involved in the real estate settlement process as in the RESPA Act of 1974 and Amendments is covered in the scope of marketing activities. Events include, but are not limited to in person events and virtual events.

Traditional Marketing: Traditional joint marketing for multiple parties involved in the real estate settlement process as in the RESPA Act of 1974 and Amendments is covered in the scope of marketing activities. Traditional marketing includes but is not limited to television advertising, newspaper advertisements, magazine advertisements, and radio advertising.

Direct Marketing: Joint direct marketing for multiple parties involved in the real estate settlement process as in the RESPA Act of 1974 and Amendments is covered in the scope of promotional activities. Direct marketing includes, but is not limited to pamphlets, postcards, flyers, posters, letters, brochures, business cards, and any form of print advertising and print or tangible promotional materials.

Marketing Software: Joint use of a marketing software by multiple parties involved in the real estate settlement process as in the RESPA Act of 1974 and Amendments is covered in the scope of promotional activities.

Kiosk service: Joint information display or use of a Kiosk for multiple parties involved in the real estate settlement process as in the RESPA Act of 1974 and Amendments is covered in the scope of Kiosk service.

Although the description above contains many specificities, these should not be construed as limiting the scope of the embodiments but as merely providing some illustrations of some of several embodiments.

### CONCLUSION, RAMIFICATIONS, AND SCOPE

The invention will allow and encourage parties involved in the real estate settlement process as in the RESPA Act of 1974 and Amendments to work together within compliance, and will allow parties involved in the real estate settlement process as in the RESPA Act of 1974 and Amendments to grow their businesses and therefore stimulate economic development of the real estate industry. The invention will allow participating parties more marketing opportunities, and it will help relieve the tension surrounding RESPA compliant engagement. It will also allow parties a safe way to confirm RESPA compliance by a non-government third party without surrendering significant marketing opportunities. The process shall be executed in good faith and intention to ensure it lies within the scope of relevant laws and a safe harbor shall be established to ensure proper documentation is kept to support all such joint marketing activities.

The scope of this patent pertains to parties involved in the real estate settlement process as in the RESPA Act of 1974 and Amendments. This includes but is not limited to real estate agents, mortgage companies, loan originators, mortgage brokers, mortgage branch managers, financial companies, private lenders, speciality lenders, title companies, closing agents, escrow agents, title agents, inspection companies, inspection agents, appraisal companies, appraisers, builders, general contractors, speciality contractors. The scope of the activities, service, or products lie within joint marketing. The scope of the patent also covers the pairing or grouping of parties involved in the real estate settlement process as in the RESPA Act of 1974 and Amendments for the purpose of RESPA compliant joint marketing.

While RESPA is the current law relevant to the real estate joint marketing, the invention also covers amendments and any changes of RESPA, and new laws that come into place that are similar to RESPA and/or are in the real estate settlement industry and relate to marketing and/or joint efforts among parties involved in the real estate settlement process as in the RESPA Act of 1974 and Amendments.

Although the description above contains many specificities, these should not be construed as limiting the scope of the embodiments but as merely providing some illustrations of some of several embodiments.

What is claimed is:

1. The ability of a non-government third party to confirm compliance pertaining to joint marketing offered as a product or a service to parties involved in the real estate settlement process as in the RESPA Act of 1974 and Amendments.

2. The ability of claim 1 is further operable to include joint marketing offered as a product or service, including but not limited to if it is offered as an additional service or a joint product or a joint service to parties involved in the real estate settlement process as in the RESPA Act of 1974 and Amendments.

3. The ability of claim 1 is further operable to maintain such records.

4. A non-government third party's ability to confirm the ethicality of joint marketing among parties involved in the real estate settlement process as in the RESPA Act of 1974 and Amendments, or a similar law, as a product or service.

5. The ability of claim 4 is further operable to maintain such records.

6. A grouping system where parties involved in the real estate settlement process as in the RESPA Act of 1974 and Amendments can participate in joint marketing activities in compliance under RESPA Act of 1974 and Amendments.
